(19) United States
(12) Patent Application Publication
(10) Pub. No.: US 2012/0065926 A1
(43) Pub. Date: Mar. 15, 2012

(54) INTEGRATED MOTION SENSING APPARATUS

(75) Inventors: Bho Ram LEE, Seongnam-si (KR); Won Chul Bang, Bundang-gu (KR)

(73) Assignee: SAMSUNG ELECTRONICS CO., LTD, Suwon-si (KR)

(21) Appl. No.: 13/082,922

(22) Filed: Apr. 8, 2011

(30) Foreign Application Priority Data
Sep. 14, 2010 (KR) 10-2010-008991

(51) Int. Cl. G06F 15/00; G01P 15/02

(52) U.S. Cl. 702/141

(57) ABSTRACT

Provided is an integrated motion sensing apparatus that may calculate first motion information associated with a target object based on an intensity of a (infrared) (IR) light measured by at least one optical sensor, may calculate second motion information associated with the target object based on inertial information measured by at least one inertial sensor, and may estimate third motion information associated with the target object based on at least one of the intensity of the light, the first motion information, the inertial information, and the second motion information.

### CROSS-REFERENCE TO RELATED APPLICATIONS

This application claims the priority benefit of Korean Patent Application No. 10-2010-0089911, filed on Sep. 14, 2010, in the Korean Intellectual Property Office, the disclosure of which is incorporated herein by reference.

### BACKGROUND

1. Field

Example embodiments relate to an integrated motion sensing apparatus that may measure information using an optical sensor and an inertial sensor, may calculate the measured information to estimate information, and may estimate motion information associated with a target object based on the estimated information.

2. Description of the Related Art

A motion sensor has been developed using various forms, such as an image sensor, an optical sensor, a ultrasonic sensor, a magnetic sensor, an inertial sensor, and the like that may measure and estimate a position and a posture of a target object.

The image sensor may photograph the target object using an image obtaining unit, that is, a camera, and may calculate the position of the target object based on the photographed still image. When the image obtaining unit does not provide three-dimensional (3D) information, that is, depth information, the image sensor may only calculate a two-dimensional (2D) position. However, when at least two image obtaining units are used, the image sensor may calculate a 3D position.

The image sensor may have difficulty in recognizing a motion without using a predetermined marker, and although the predetermined marker is provided, the image sensor may not accurately calculate the position and the posture of the target object at a high-speed due to a limited calculation capability.

The ultrasonic sensor may measure a distance of the target object using a transmitting unit and a receiving unit, and may calculate the position and the posture of the target object using multiple pairs of transmitting units and receiving units.

The magnetic sensor may estimate the posture of the target by measuring terrestrial magnetism of the target object or artificially generated magnetism. When a geomagnetic field is measured, the magnetic sensor may determine an absolute radiational angle that is based on a magnetic north, and when an artificially generated magnetic field is measured, the magnetic sensor may calculate a relative posture from with respect to a magnetic field source.

The image sensor, the ultrasonic sensor, and the magnetic sensor may be dependent on an external source and an external condition, such as reflection of light, transmission and reception of ultrasonic waves, generation and measurement of a magnetic field, and the like.

The inertial sensor may output a measurement value at a relatively high sampling rate and has a feature of measuring self-containing physical properties. However, when the position and the posture of the target object are calculated, the inertial sensor may not be solely used for a relatively long time and periodical adjustment of the sensor, the integrator, and the like, may be performed to reduced error.

### SUMMARY

The foregoing and/or other aspects are achieved by providing an integrated motion sensing apparatus, the apparatus including a first motion sensing unit to calculate first motion information associated with a target object based on an intensity of an (infrared) light measured by at least one optical sensor, a second motion sensing unit to calculate second motion information associated with the target object based on inertial information measured by at least one inertial sensor, and a motion estimator to estimate third motion information associated with the target object based on at least one of the intensity of the (infrared) light, the first motion information, the inertial information, and the second motion information.

The foregoing and/or other aspects are achieved by providing an integrated motion sensing apparatus, the apparatus including a first motion sensing unit to calculate first motion information associated with a target object based on an intensity of an (infrared) light measured by at least one optical sensor, a second motion sensing unit to measure inertial information associated with the target object, using at least one inertial sensor, and a motion estimator to estimate second motion information associated with the target object based on the first motion information and the inertial information.

The foregoing and/or other aspects are achieved by providing an integrated motion sensing apparatus, the apparatus including a first motion sensing unit to measure an intensity of an (infrared) light reflected from a target object, using at least one optical sensor, a second motion sensing unit to calculate first motion information associated with the target object based on inertial information measured by at least one inertial sensor, and a motion estimator to estimate second motion information associated with the target object based on the intensity of the (infrared) light and the first motion information.

The foregoing and/or other aspects are achieved by providing an integrated motion sensing apparatus, the apparatus including a first motion sensing unit to measure an intensity of an (infrared) light reflected by a target object, using at least one optical sensor, a second motion sensing unit to measure inertial information associated with the target object, using at least one inertial sensor, and a motion estimator to estimate motion information associated with the target object based on the intensity of the (infrared) light and the inertial information.

The foregoing and/or other aspects are achieved by providing an integrated motion sensing apparatus, the apparatus including a first motion sensing unit to calculate first motion information associated with a target object based on an intensity of an (infrared) light measured by at least one optical sensor, a second motion sensing unit to calculate second motion information associated with the target object based on inertial information measured by at least one inertial sensor, and a motion estimator to estimate third motion information associated with the target object based on the first motion information and the second motion information.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 is a block diagram illustrating a configuration of an integrated motion sensing apparatus according to an example embodiment.

FIG. 2 is a block diagram illustrating a configuration of an integrated motion sensing apparatus according to an example embodiment.

FIG. 3 is a block diagram illustrating a configuration of an integrated motion sensing apparatus according to another example embodiment;

FIG. 4 is a block diagram illustrating a configuration of an integrated motion sensing apparatus according to still another example embodiment;

FIG. 5 is a block diagram illustrating a configuration of an integrated motion sensing apparatus according to yet another example embodiment; and

FIG. 6 is a block diagram illustrating a configuration of an integrated motion sensing apparatus according to further example embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

An integrated motion sensing apparatus may estimate a position, a posture, and the like of a target object using at least two motion sensors from among various types of motion sensors and thus, may more accurately measure a motion of the target object.

The integrated motion sensing apparatus may include a first motion sensing unit to measure an infrared (IR) light emitted from at least one light source using at least one optical sensor, and to calculate a position, a posture, a direction the target object is moving towards, and the like, based on an intensity of the measured IR light.

The integrated motion sensing apparatus may include a second motion sensing unit to measure inertial information associated with the motion of the target object, using an inertial sensor such as an accelerometer including at least one axis, a gyroscope (gyro) including at least one axis, and the like, and to calculate, based on the measured inertial information, the position, the posture, the direction the target object is moving towards, and the like.

The integrated motion sensing apparatus may more accurately measure the motion of the target object, by integrating at least two motion sensing units, such as the first motion sensing unit and the second motion sensing unit.

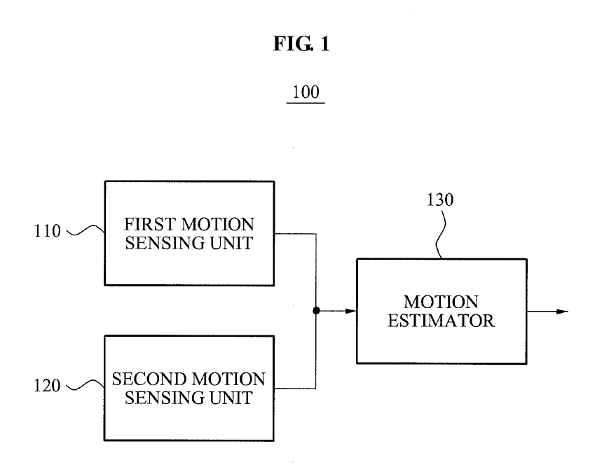

FIG. 1 illustrates a configuration of an integrated motion sensing apparatus 100 according to an example embodiment.

Referring to FIG. 1, the integrated motion sensing apparatus 100 may include a first motion sensing unit 110, a second motion sensing unit 120, and a motion estimator 130.

The first motion sensing unit 110 may calculate first motion information associated with a target object based on an intensity of an IR light measured by at least one optical sensor.

The second motion sensing unit 120 may calculate second motion information associated with the target object based on inertial information measured by at least one inertial sensor.

The motion estimator 130 may estimate third motion information associated with the target object based on at least one of the intensity of the IR light (the first motion information) and, the inertial information (the second motion information).

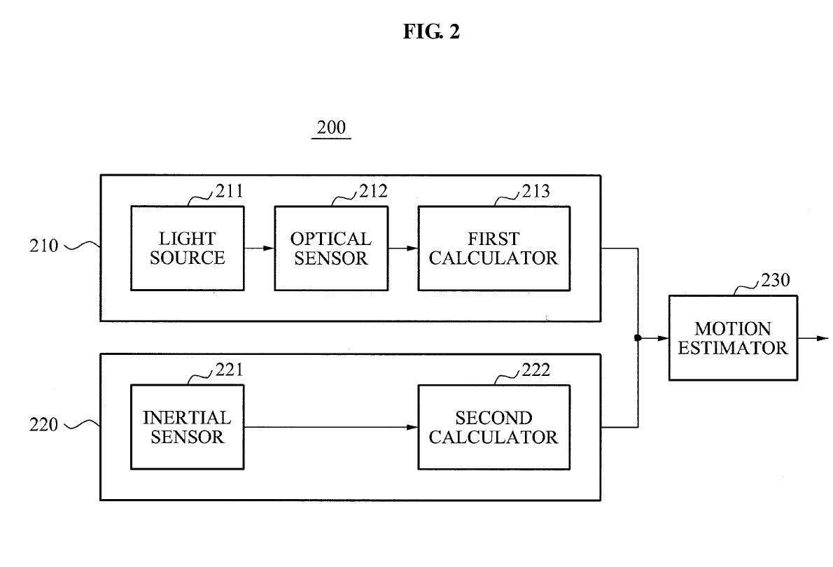

FIG. 2 illustrates a detailed configuration of an integrated motion sensing apparatus 200 according to an example embodiment.

A first motion sensing unit 210 may sense a motion of a target object using a light source 211, for example, an IR light. The first motion sensing unit 210 may measure the IR light emitted from at least one the light source 211 using at least one optical sensor 212, and may calculate, a position, a posture, a direction the target object is moving towards, and the like, based on an intensity of the measured IR light.

The first motion sensing unit 210 may include a first calculator 213 to calculate first motion information associated with the target object, such as the position of the target object, the posture of the target object, the direction the target object is moving towards, and the like.

When an iteration is to be performed while the position, the posture, the direction the target object is moving, and the like are calculated, the first motion sensing unit 210 may calculate the first motion information by applying, to at a seeding point, the position, the posture, the direction calculated at a sampling time.

The second motion sensing unit 220 may include an inertial sensor 221 including inertial measurement units, such as an accelerator including at least one axis, a gyro including at least one axis, and the like.

The inertial sensor 221 may measure inertial information, such as an acceleration, an angular rate, and the like associated with a motion of the target object.

The second motion sensing unit 220 may include a second calculator 222 to receive the inertial information measured by the inertial sensor 221, and to calculate second motion information such as an integrated velocity of the target object, an integrated position of the target object, an integrated posture of the target object, an integrated direction the target object is moving towards, and the like.

The second motion sensing unit 220 may be an inertial navigation system (INS), and may start calculation of integration associated with the position of the target object, the posture of the target object, and the direction the target object is moving towards when an initial value is given.

When the second motion sensing unit 220 is used, the second motion sensing unit 220 may calculate coordinate transformation information, that is, information associated with the posture, and may enhance a performance by inputting sensor correction information, such as bias correction information, a relative scale factor, and the like.

For example, the integrated motion sensing apparatus 200 may calculate, using the first motion sensing unit 210, the first motion information including the position of the target object and the direction the target object is moving, and may calculate, using the second motion sensing unit 220, the second motion information including the position of the target object and the direction the target object is moving.

For another example, the integrated motion sensing apparatus 200 may calculate, using the first motion sensing unit 210, the first motion information including the position of the target object and the direction the target object is moving, and may generate, based on the first motion information, third motion information by correcting the inertial information.

The motion estimator 230 may feed back the estimated third motion information to the optical sensor 212 or the inertial sensor 221.

The integrated motion sensing apparatus may track a three-dimensional (3D) motion and thus, may be applied to a 3D display, an interactive game, and a virtual reality (VR) system.

For example, the integrated motion sensing apparatus may be utilized as a motion sensing remote controller, a 3D pointing device, a 3D user interface, and the like.

When the integrated motion sensing apparatus is applied to an image guided surgery that tracks a position of a surgical instrument in real time and provides information associated with the position of the surgical instrument for convenience of surgery, while periodically obtaining a magnetic resonance image (MRI) or a computed tomography (CT) image during a surgery on the brain, the spine, the knee, the pelvis, the hip joint, the ear, nose, and throat (ENT), and the like, the integrated motion sensing apparatus may track the position of the surgical instrument from the obtained image.

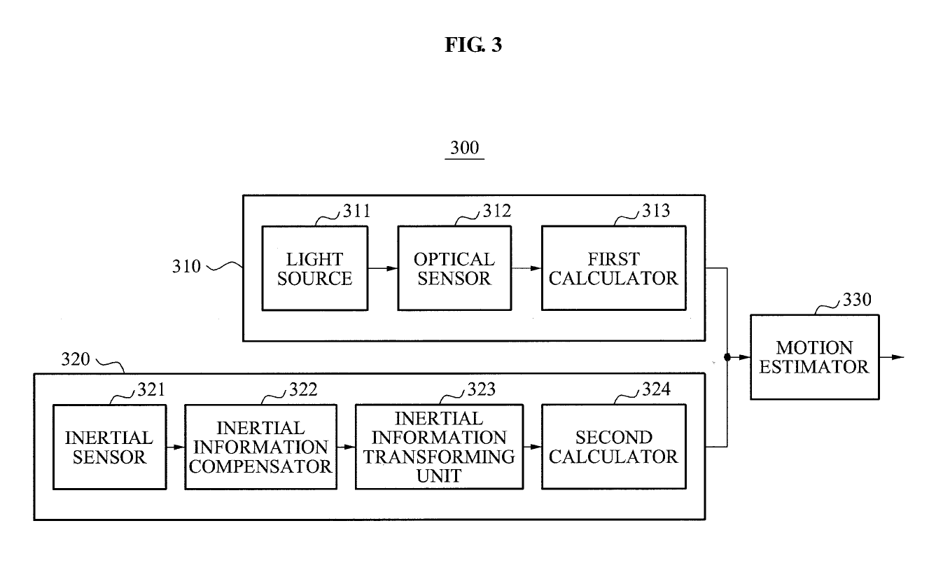

FIG. 3 illustrates a configuration of an integrated motion sensing apparatus 300 according to another example embodiment.

The integrated motion sensing apparatus 300 may includes a first motion sensing unit 310, a second motion sensing unit 320, and a motion estimator 330. The first motion sensing unit 310 and the second motion sensing unit 320 may separately operate and may calculate first motion information and second motion information, respectively. The motion estimator 330 may calculate third motion information including a new position of a target object, a posture of the target object, a direction the target object is moving, and the like.

The second motion sensing apparatus 320 may include an inertial information compensator 322 that performs bias correction and relative scale correction with respect to inertial information.

The second motion sensing unit 320 may include an inertial information transforming unit 323 to transform the corrected inertial information to coordinate information associated with the second motion information.

The motion estimator 330 may receive a first output from the first motion sensing unit 310 and a second output from the second motion sensing unit 320, the same physical property as an input, respectively, and may output the third motion information based on weighted sum as expressed by Equation 1.

\hat{x}=α·x_{INS}+(1−α)·x_{IR} [Equation 1]

In Equation 1, X_{IR} denotes the first motion information, X_{INS} denotes the second motion information, \hat{x} denotes the third motion information, and a denotes a weight parameter.

The integrated motion sensing apparatus 300 may use various a to calculate the third motion information. For example, a may be set to be 0.5, so that the first motion information and the second motion information are equally applied.

The integrated motion sensing apparatus 300 may set α that varies over time (α=α(t)), based on a characteristic of the input signal.

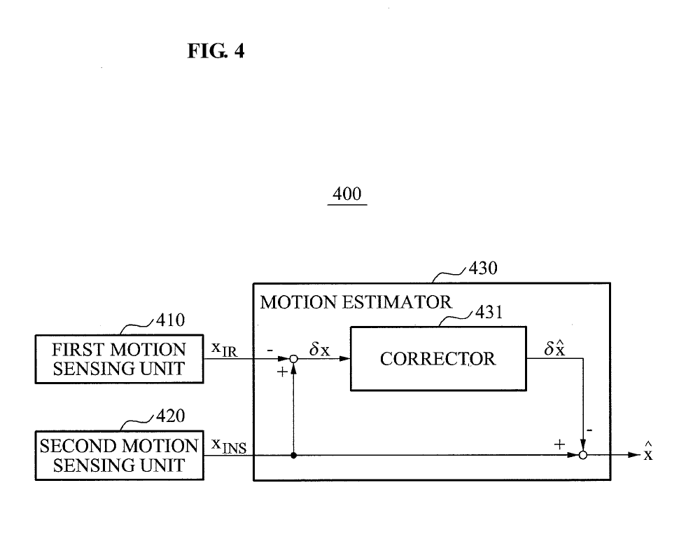

FIG. 4 illustrates a configuration of an integrated motion sensing apparatus 400 according to still another example embodiment.

The integrated motion sensing apparatus 400 may receive first motion information and second motion information respectively from a first motion sensing unit 410 and a second motion sensing unit 420, may estimate third motion information, may correct a state variable associated with the third motion information using a motion estimator 430, and may estimate more accurate information.

The motion estimator 430 may include a corrector 431 that corrects the third motion information based on estimated error with respect to the first motion information or the second motion information, and estimates fourth motion information.

For example, when a complementary Kalman filter is used as the corrector 431, the motion estimator 430 may estimate an error of a primary state variable with respect to the third motion information and thus, may correct the state variable with respect to the third motion information to estimate the fourth motion information.

When a position and a direction a target object is moving towards associated with the first motion information and the second motion information are received and the received position and direction have the same physical properties, the fourth motion information may be estimated by calculating an estimated error with respect to values that are different, the difference being determined based on the position and the direction included in the second motion information.

When the first motion information is reference information associated with integrated motion information, the motion estimator 430 may estimate fifth motion information by integrating the fourth motion information and the first motion information.

When the second motion information is the reference information associated with the integrated motion information, the motion estimator 430 may estimate sixth motion information by integrating the fourth motion information and the second motion information.

For example, when the second motion information is the reference information associated with the integrated motion information, the motion estimator 430 may calculate the third motion information δx that is difference between the first motion information and the second motion information.

The motion estimator 430 may calculate an estimated value δ\hat{x} that enables the difference to be zero by using the third motion information δx as the input of the complementary Kalman filter, and may estimate the sixth motion information by adding the estimated value δ\hat{x} and the second motion information.

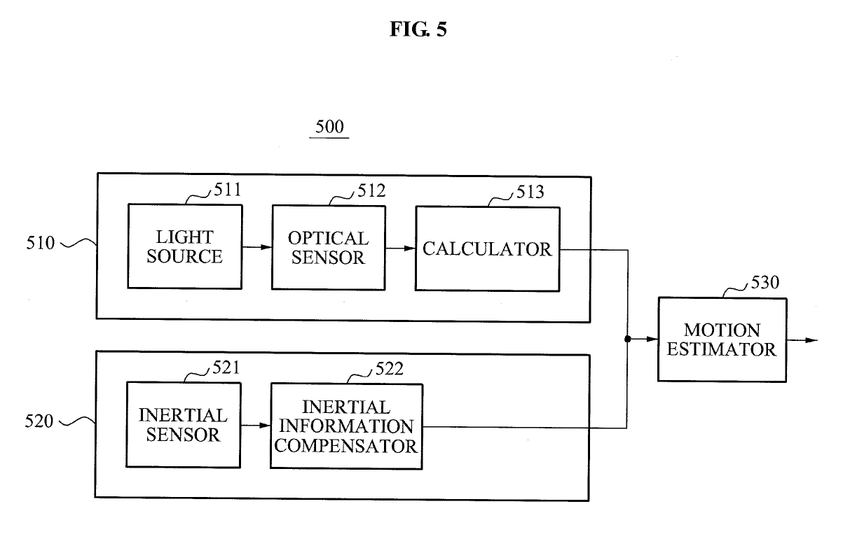

FIG. 5 illustrates a configuration of an integrated motion sensing apparatus 500 according to yet another example embodiment.

Referring to FIG. 5, the integrated motion sensing apparatus 500 may include a first motion sensing unit 510, a second motion sensing unit 520, and a motion estimator 530.

The first motion sensing unit 510 may measure an IR light, as an example, emitted from a light source 511 using at least one optical sensor 512, and may calculate, using a calculator 513, first motion information associated with a target object based on an intensity of the IR light.

The calculator 513 may calculate the first motion information including at least one of a position of the target object, a posture of the target object, and a direction the target object is moving towards.

The second motion sensing unit 520 may measure inertial information associated with the target object using at least one inertial sensor 521, and may correct (or compensate) the measured inertial information using the inertial information corrector (or inertial information compensator) 522.

The inertial information may include various inertial information, such as an acceleration, an angular rate, and the like associated with a motion of the target object.

The motion estimator 530 may estimate second motion information associated with the target object based on the first motion information and the inertial information.

The integrated motion sensing apparatus 500 may correct, based on the inertial information, the first motion information calculated by the first motion sensing unit 510 and thus, may estimate the second motion information.

For example, the first motion sensing unit 510 may perform, based on an equation of motion, modeling of the first motion information that may be state variables associated with the position and the posture of the target object, and may provide the modeled first motion information to the motion estimator 530.

The second motion sensing unit 520 may measure, using the inertial sensor 521, the inertial information including an acceleration of motion and an acceleration of gravity, and may provide the inertial information to the motion estimator 530.

The motion estimator 530 may receive the first motion information and the inertial information as measurement vectors, and may correct the received information based on an extended Kalman filter.

For example, the integrated motion sensing apparatus 500 may define a state vector and a measurement vector as expressed by Equations 2 and 3.

x=[qδωpva^{b}]^{T} [Equation 2]

z=[q_{IR}p_{IR}ã]^{T} [Equation 3]

In this case, variables used in Equations 2 and 3 may be defined as shown in Table 1, however, are not limited thereby.

TABLE 1

| | |
|---|---|
| q | Orientation (quaternion, [q₀ q₁ q₂ q₃]^{T}) |
| ω | Angular rate ([ωₓ ω_{y} ω_{z}]^{T}) |
| \tilde{ω} | Angular rate measurement (gyro outputs) |
| δ\tilde{ω} | Gyro bias |
| C_{b}ⁿ | the Direction Cosine Matrix (from body-frame to navigation-frame) |
| p | Position vector ([x y z]^{T}) |
| v | Velocity vector ([vₓ v_{y} v_{z}]^{T}) |
| a | Translation acceleration vector ([aₓ a_{y} a_{z}]^{T}) |
| g | Gravitational acceleration vector ([0 0 −9.81(m/s²)]^{T}) |
| ã | Acceleration measurement (accelerometer outputs) |
| x | Kalman filter state vector (x = [q δω p v a^{b}]^{T}) |
| w | State disturbance vector |
| z | Kalman filter measurement vector (z = [q_{IR} p_{IR} ã]^{T}) |
| n | Measurement noise vector |

As an equation of motion associated with the state variables, Equation 4 that is a quaternion relational expression and Equation 5 that is an angular rate relational expression may be used.

$$\dot{q} = {\frac{1}{2} [ {ω}_{k} ]}_{x} {q}^{T} \qquad [ Equation 4 ]$$

$${[ {ω}_{k} ]}_{x} = [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & {ω}_{y} & - {ω}_{x} & 0\end{matrix} ] \qquad [ Equation 5 ]$$

As a relational expression associated with a position, a velocity, and an acceleration included in the second motion information, Equation 6 may be used.

\dot{p}=v

\dot{v}=C_{b}ⁿa^{b} [Equation 6]

In Equation 6, c_{b}ⁿ denotes a matrix indicating transformation from a body frame to a reference frame.

A system model to be used for calculating the subsequent state of the state variables may be calculated based on Equations 7 through 12.

$$\begin{matrix}{q}_{k + 1} = {q}_{k} + {\frac{d t}{2} [ {ω}_{k} ]}_{x} {q}_{k} + {w}_{q} & [ Equation 7 ] \\ {ω}_{k} = \tilde{ω} + δ {ω}_{k} & [ Equation 8 ] \\ δ {ω}_{k} = δ \tilde{ω} + {w}_{δ ω} & [ Equation 9 ] \\ {p}_{k + 1} = {p}_{k} + d t \cdot {v}_{k} + \frac{d {t}^{2}}{2} \cdot {C}_{b}^{n} ( {q}_{k} ) \cdot {a}^{b} + {w}_{p} & [ Equation 10 ] \\ {v}_{k + 1} = {v}_{k} + d t \cdot \cdot {C}_{b}^{n} ( {q}_{k} ) \cdot {a}^{b} + {w}_{v} & [ Equation 11 ] \\ {a}_{k + 1}^{b} = {a}_{k}^{b} + {w}_{a} & [ Equation 12 ]\end{matrix}$$

A gyro bias and an acceleration that are the state variables may be assumed to be constants, and a measurement model to be used for calculating the subsequent state of measurement variables may be calculated based on Equation 13.

$${z}_{k} = [ \begin{matrix}{q}_{IR} \\ {p}_{IR} \\ \tilde{a}\end{matrix} ] = [ \begin{matrix}{q}_{IR , k} \\ {p}_{IR , k} \\ {a}_{k}^{b} + {C}_{n}^{b} ( {q}_{k} ) \cdot g\end{matrix} ] \qquad [ Equation 13 ]$$

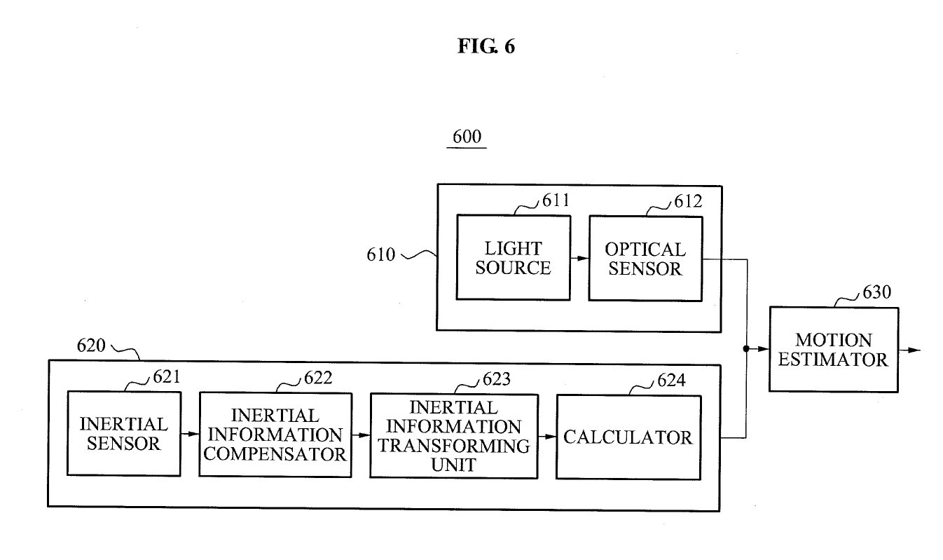

FIG. 6 illustrates a configuration of an integrated motion sensing apparatus 600 according to further example embodiment.

The integrated motion sensing apparatus 600 may include a first motion sensing unit 610, a second motion sensing unit 620, and a motion estimator 630.

The first motion sensing unit 610 may emit at least one IR light to a target object using at least one light source 611, may measure an intensity of an IR light reflected from the target object using at least one optical sensor 612, and may output the measured intensity of the IR light to the motion estimator 630.

The second motion sensing unit 620 may calculate first motion information associated with the target object based on inertial information measured by at least one inertial sensor.

The inertial information may include various inertial information, such as an acceleration, an angular rate, and the like associated with a motion of the target object.

The second motion sensing unit 620 may include an inertial information compensator 622 that performs bias correction, a relative scale correction, and the like with respect to the inertial information.

The second motion sensing unit 620 may include an inertial information transforming unit 623 that transforms the corrected (or compensated) inertial information to coordinate information associated with the first motion information.

The second motion sensing unit 620 may include a calculator 624 that calculates the first motion information including at least one of an integrated velocity of the target object, an integrated position of the target object, an integrated posture of the target object, and an integrated direction the target object is moving.

The integrated motion sensing apparatus 600 may estimate, using the motion estimator 630, the second motion information associated with the target object based on the intensity of the IR light and the first motion information.

Depending on embodiments, an integrated motion sensing apparatus may include a first motion sensing unit that measures an intensity of an IR light reflected from a target object using at least one optical sensor, a second motion sensing unit that measures inertial information associated with the target object using at least one inertial sensor, and a motion estimator that estimates motion information associated with the target object based on the intensity of the IR light and the inertial information.

Depending on embodiments, an integrated motion sensing apparatus may include a first motion sensing unit that calculates first motion information associated with a target object based on an intensity of an IR light measured by at least one optical sensor, a second motion sensor that calculates second motion information associated with the target object based on the measured inertial information using at least one inertial sensor, and a motion estimator that estimates third motion information associated with the target object based on the first motion information and the second motion information.

The example embodiments may include an integrated motion sensing apparatus including at least two sensors that may accurately and reliably estimate a position and a posture of a target object.

The example embodiments may include an integrated motion sensing apparatus that may seamlessly estimate a motion of a target object even when a single sensor does not receive motion information associated with the target object.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An integrated motion sensing apparatus, the apparatus comprising:
a first motion sensing unit to calculate first motion information associated with a target object based on an intensity of an infrared light measured by at least one optical sensor;
a second motion sensing unit to calculate second motion information associated with the target object based on inertial information measured by at least one inertial sensor; and
a motion estimator to estimate third motion information associated with the target object based on at least one of the intensity of the infrared light, the first motion information, the inertial information, the second motion information, or the combination thereof.

2. The apparatus of claim 1, wherein the first motion sensing unit comprises a first calculator to calculate the first motion information including at least one of position of the target object, a posture of the target object, and a direction the target object is moving towards.

3. The apparatus of claim 1, wherein the inertial information includes at least one of an acceleration and an angular rate associated with a motion of the target object.

4. The apparatus of claim 1, wherein the second motion sensing unit comprises a second calculator to calculate the second motion information including at least one of an integrated velocity of the target object, an integrated position of the target object, an integrated posture of the target object, and an integrated direction the target object is moving towards.

5. The apparatus of claim 1, wherein the second motion sensing unit comprises:
an inertial information compensator to compensate a bias and relative scaled based upon the inertial information; and
inertial information transforming unit to transform the compensated inertial information to coordinate information associated with the second motion information.

6. The apparatus of claim 1, wherein the motion estimator feeds back the third motion information to the optical sensor or the inertial sensor.

7. The apparatus of claim 1, wherein the motion estimator comprises:
a corrector to estimate fourth motion information by correcting the third motion information based on an estimated error associated with the first motion information or an estimated error associated with the second motion information.

8. The apparatus of claim 7, wherein the motion estimator estimates fifth motion information by adding the fourth motion information and the first motion information when the first motion information is reference information with respect to the integrated motion information, and estimates sixth motion information by adding the fourth motion information and the second motion information when the second motion information is the reference information with respect to the integrated motion information.

9. An integrated motion sensing apparatus, the apparatus comprising:
a first motion sensing unit to calculate first motion information associated with a target object based on an intensity of a light measured by at least one optical sensor;
a second motion sensing unit to measure inertial information associated with the target object, using at least one inertial sensor; and
a motion estimator to estimate second motion information associated with the target object based on the first motion information and the inertial information.

10. The apparatus of claim 9, wherein the first motion sensing unit comprises:
a calculator to calculate the first motion information including at least one of a position associated with the target object, a posture associated with the target object, and a direction the target object is moving.

11. The apparatus of claim 9, wherein the inertial information includes at least one of an acceleration and an angular rate associated with a motion of the target object.

12. The apparatus of claim 10, wherein the second motion sensing unit comprises an inertial information compensator to compensate the measured inertial information.

13. An integrated motion sensing apparatus, the apparatus comprising:
a first motion sensing unit to measure an intensity of a light reflected from a target object, using at least one optical sensor;
a second motion sensing unit to calculate first motion information associated with the target object based on inertial information measured by at least one inertial sensor; and
a motion estimator to estimate second motion information associated with the target object based on the intensity of the infrared light and the first motion information.

14. The apparatus of claim 13, wherein the inertial information includes at least one of an acceleration and an angular rate associated with a motion of the target object.

15. The apparatus of claim 13, wherein the second motion sensing unit comprises:
a calculator to calculate the first motion information including at least one of integrated velocity of the target object, an integrated position of the target object, an integrated posture of the target object, and an integrated direction the target object is moving.

16. The apparatus of claim 13, wherein the second motion sensing unit comprises an inertial information compensator to compensate the measured inertial information.

17. The apparatus of claim 13, wherein the second motion sensing unit comprises an inertial information transforming unit to transform the compensated inertial information to coordinate information associated with the second motion information.

18. An integrated motion sensing apparatus, the apparatus comprising:
a first motion sensing unit to measure an intensity of a light reflected by a target object, using at least one optical sensor;
a second motion sensing unit to measure inertial information associated with the target object, using at least one inertial sensor; and
a motion estimator to estimate motion information associated with the target object based on the intensity of the light and the inertial information.

19. The apparatus of claim 18, wherein the inertial information includes at least one of an acceleration and an angular rate associated with a motion of the target object.

20. The apparatus of claim 18, wherein the motion estimator estimates the motion information including at least one of an integrated velocity of the target object, an integrated position of the target object, an integrated posture of the target object, and an integrated direction the target object is moving.

21. An integrated motion sensing apparatus, the apparatus comprising:
a first motion sensing unit to calculate first motion information associated with a target object based on an intensity of a light measured by at least one optical sensor;
a second motion sensing unit to calculate second motion information associated with the target object based on inertial information measured by at least one inertial sensor; and
a motion estimator to estimate third motion information associated with the target object based on the first motion information and the second motion information.

22. The apparatus of claim 21, wherein the first motion sensing unit comprises a first calculator to calculate the first motion information including at least one of a position of the target object, a posture of the target object, and a direction the target object is moving.

23. The apparatus of claim 21, wherein the inertial information includes at least one of an acceleration and an angular rate associated with a motion of the target object.

24. The apparatus of claim 21, wherein the second motion sensing unit comprises a second calculator to calculate the second motion information including at least one of an integrated velocity of the target object, an integrated position of the target object, an integrated posture of the target object, and an integrated direction the target object is moving.

25. The apparatus of claim 21, wherein the light is an infrared light.
